(19) United States
(12) Patent Application Publication
(10) Pub. No.: US 2026/0141403 A1
(43) Pub. Date: May 21, 2026

(54) Solving Micro-Escalation Events with Machine Learning Models

(71) Applicant: Sierra Technologies, Inc., San Francisco, CA (US)

(72) Inventors: Clayton Woodward Bavor, Jr., Atherton, CA (US); Arya Asemanfar, San Francisco, CA (US)

(21) Appl. No.: 19/391,789

(22) Filed: Nov. 17, 2025

Related U.S. Application Data
(60) Provisional application No. 63/723,452, filed on Nov. 21, 2024.

(51) Int. Cl. G06Q 30/015; G06F 40/20; G06F 40/35; G06F 40/40; G06Q 10/0631

(52) U.S. Cl. CPC G06Q 30/015; G06F 40/20; G06F 40/35; G06F 40/40; G06Q 10/063116

(57) ABSTRACT

A system uses a machine-learning model to solve micro-escalation events. The system receives, from an artificial intelligence (AI) agent, a stream of input data from a user during a real-time conversation between the AI agent and the user. The system applies the machine-learning model to the stream of input data to identify micro-escalation events. The system creates a communication channel between the agent and one or more human operators. The system assigns each micro-escalation event to a human operator via the communication channel. The system receives a result generated by a respective human operator for each micro-escalation event via the communication channel. The system dynamically integrates the results to form an overall response to the stream of input data from the agent into the real-time conversation.

### CROSS REFERENCE TO RELATED APPLICATION

This application claims the benefit of U.S. Provisional Application No. 63/723,452, filed Nov. 21, 2024, which is incorporated by reference.

### TECHNICAL FIELD

The disclosure generally relates to the field of artificial intelligence, and more specifically relates to a declarative agent that uses machine-learning models.

### BACKGROUND

Agents are software that coordinate sequences of interactions with AI (artificial intelligence), such as LLMs (large language models) and external software systems. Users may interact with AI agents such that the AI agents complete tasks provided by a user. However, in some scenarios, intervention by a human operator may be more efficient rather than allowing the AI agent to continue handling a task. These events often arise when the task involves complex reasoning, nuanced understanding, or sensitive issues. In scenarios where an AI agent attempts to resolve a problem that is better suited for a human operator, the AI agent may take actions that do not align with human nuances, customer expectations, or company policies, leading to negative outcomes and/or wasting significant computational resources without yielding an effective solution. When an AI agent mishandles an issue that should have been escalated sooner, the problem may worsen or escalate in severity, which can lead to increased customer dissatisfaction and more complicated resolution processes. Turning over an entire conversation to a human agent can be inefficient, especially when parts of a task or other tasks are straightforward and well-suited to AI agents, and transferring the whole conversation for every complex case increases the workload on human agents. This strains resources and may increase wait times for other customers needing assistance. Additionally, unnecessary or delayed take-over events can create overload for human operators, affecting operational efficiency and employee morale.

### SUMMARY

Systems and methods are disclosed herein address micro-escalation events. In this disclosure, a system trains a machine-learning model to identify whether/when a stream of input data needs/triggers a take-over event during a real-time conversation. The system continuously monitors the conversation between the AI agent and the user to detect specific patterns or features indicating that human intervention is necessary. By using the model on data of the conversation, the system may proactively detect when human intervention is required, rather than relying on user frustration to escalate the situation (e.g., by the user requesting a human operator or the system not acting until frustration is detected). This ensures that users receive timely and appropriate support, preventing small issues from becoming larger problems. Additionally, instead of switching control completely to a human operator, the system allows for collaboration where the human operator handles the take-over events, and the AI agent handles other events. Once the human operator resolves the issue, the result is sent back to the AI agent, which continues the ongoing conversation with the user. The AI agent integrates the human operator's solution into the dialogue in a natural way. This method saves the human operator's time by allowing them to focus on resolving specific tasks rather than managing the entire conversation. By returning the result to the computer agent, the system ensures consistency in the interaction. It also reduces user frustration since the interaction flow with the computer agent is not interrupted or handed off to another person, which can often feel jarring or inconsistent.

In this way, an efficient escalation of take-over events is provided for balancing technology and human resources. The disclosed systems and methods reduce waste of computing resources by recognizing when computer agent's capabilities are insufficient, avoid escalation due to frustration by promptly addressing issues that need human intervention, and prevent workload overload by only escalating cases that truly require human expertise.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a system environment for implementing a declarative agent service, in accordance with one or more embodiments.

FIG. 2 is a block diagram of declarative agent service 130, in accordance with one or more embodiments.

FIG. 3 is a flowchart for a method of solving micro-escalation events using a communication channel, in accordance with one or more embodiments.

FIG. 4 is a block diagram illustrating components of an example machine able to read instructions from a machine-readable medium and execute them in a processor (or controller), in accordance with one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

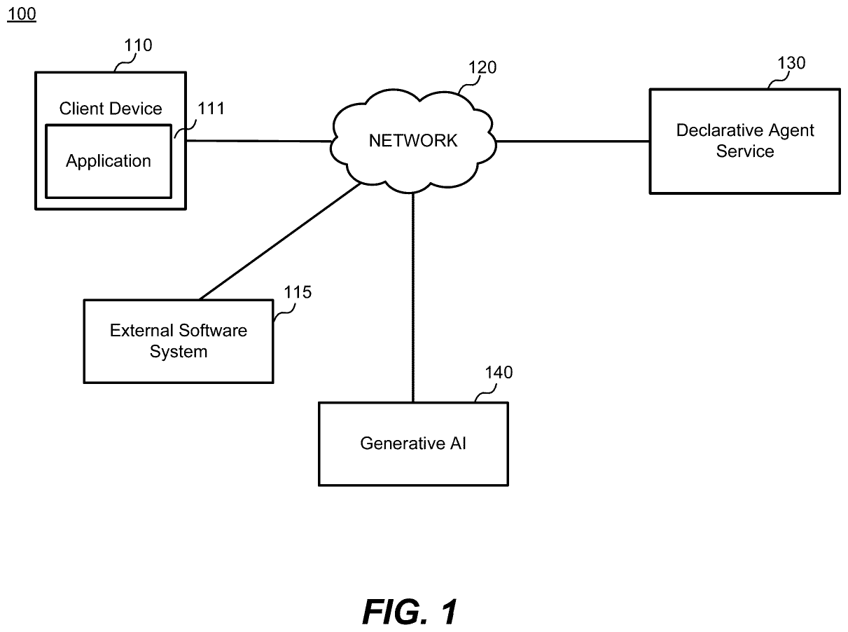

FIG. 1 illustrates a system environment for implementing a declarative agent service, in accordance with one or more embodiments. As depicted in FIG. 1, declarative agent service environment 100 includes client device 110. While application 111 is only depicted with respect to one client device 110, this is for convenience only, and any number of client devices may interact with declarative agent service 130. Client device 110 may be any device operated by an end-user with access to a user interface, such as a smartphone, a laptop, a personal computer, a wearable (e.g., smart watch), a kiosk, or any other electronic device capable of interfacing between a user and declarative agent service 130.

Declarative agent service 130 may be accessed by client device 110 using application 111. Application 111 may be an application dedicated to activities of declarative agent service 130 (e.g., an installed software package downloaded from declarative agent service 130 or an external repository such as an app store, or installed using other means such as a hard disk). Alternatively or additionally, application 111 may be a browser through which declarative agent service 130's functionality may be accessed (e.g., directly, or indirectly through an embedded portal in a website of third party company).

External software system 115 may be a software system of, e.g., a platform that utilizes declarative agent service 130. External software system 115 may require human intervention or may be utilized without a human in the loop, and may be configured to provide functionality, such as chatbot (interchangeably used with “chat automation system”) functionality to users of the platform. Client device 110 may be used by an entity controlling external software system 115 to communicate to declarative agent service 130 information sufficient to deploy guardrails on LLM outputs and/or may be used by end-users interacting with external software system 115 to resolve and otherwise chat through an issue.

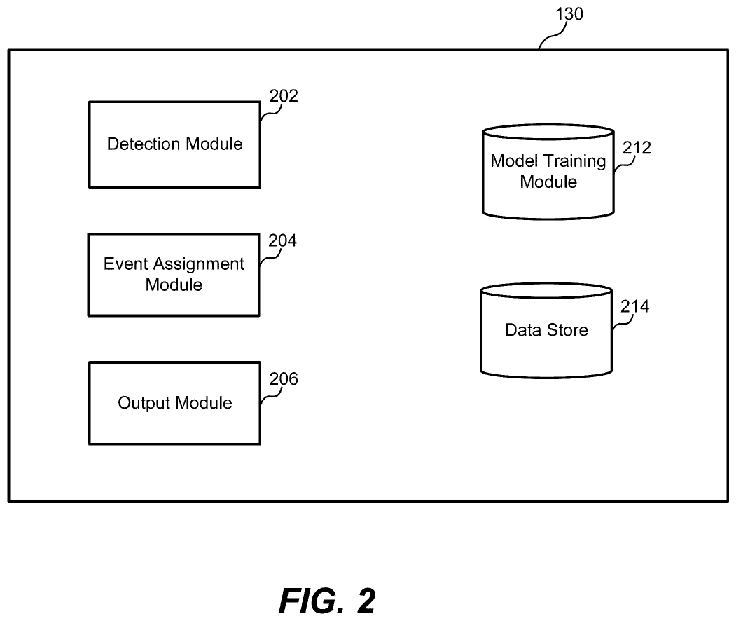

Declarative agent service 130 is used by client devices 110 and/or security device 113) and/or external software system 115 to provide a chat interface that addresses inquiries by users or by the platform of an external software system. Declarative agent service 130 is instantiated on one or more servers, accessible by way of network 120. Some or all functionality of declarative agent service 130 described herein may be distributed or fully performed by application 111 on a client device, or vice versa. Where reference is made herein to activity performed by application 111, it equally applies that declarative agent service 130 may perform that activity off of client device 110, and vice versa. Declarative agent service 130 may be provided as a software development kit (SDK) to a client device or external software service to enable these entities to build the functionality of declarative agent service 130 on-premises. The SDK may export an API such that 3rd parties (e.g., client devices or external software services) can specify their agents. Agent code using the SDK API is then uploaded to declarative agent service 130, on which it can execute (and run as an agent). Further details about the operation of declarative agent service 130 are described below with reference to FIG. 2.

Generative AI 140 may be part of declarative agent service 130 or may be a third-party provider (e.g., OpenAI) that provides generative AI for processing natural language queries. Generative AI 140 may include one or many LLMs, the LLMs provided by any number of providers.

FIG. 2 is a block diagram of declarative agent service 130, in accordance with one or more embodiments. As depicted in FIG. 2, the declarative agent service 130 includes detection module 202, an event assignment module 204, an output module 206, a model training module 212, and a data store 214. These modules and databases are merely illustrative; fewer or more modules and/or databases may be used to achieve the functionality disclosed herein.

The detection module 202 receives a stream of input data from a user during a real-time conversation between an agent of the declarative agent service 130 and the user. In some embodiments, the detection module 202 receives the stream of input data in response to establishing communication between the agent and user, which the detection module 202 may do in response to receiving a request from a human operator or based on another triggering condition. The detection module 202 may configure the agent to provide queries in the conversation to determine whether the user is interested in a task, item, or request related to a human operator. Examples of such human operators include a human operator trained to facilitate a task, provide access to an item, or handle a request, which may be difficult for the agent to handle. The agent may additionally or alternatively be configured to select which users to connect with and collect intake information (e.g., name, address, email) from the users.

The detection module 202 may scan the stream of input data and identify whether the input data includes one or more take-over events are needed to generate the response to the input data. A take-over event may refer to a micro-escalation event, which is a query/task/request that may need to be handled and/or may be more effectively handled by a human operator rather than the agent. In some embodiments, a take-over event may be easily resolved by a human operator but may require a lot of computing resources and/or may be mishandled if it was handled by an AI agent. Examples of such take-over events include warranty claims, refunds, and the user showing interest in a task or item associated with a human operator. In some embodiments, a take-over event may be a sub-task and/or a step of a whole event. In one example, a take-over event includes issues that demand significant computational resources. The agent of the declarative agent service 130 may rely on algorithms and/or predefined data sets to generate responses, and some tasks may require more processing than is practical or efficient for the agent. In yet another example, a take-over event includes situations that are likely to lead to mistakes, misunderstandings, or responses that frustrate the user.

In some embodiments, the detection module 202 tracks perceived temperament of the user while scanning for data and stores an indication of the user's temperament in the data store 214. For instance, the detection module 202 may detect instances of positive of negative sentiment and store data associated with the detected instances in the data store 214. The detection module 202 may access this sentiment information to determine whether to establish future communications between the agent and user. For example, the detection module 202 may only establish communications with users associated with neutral or positive overall sentiment. The detection module 202 may also analyze the input data to detect voicemail information or fax information in the input data and store an indication that connecting to the user resulted in going to the user's voicemail or being provided with fax information.

In some embodiments, the detection module 202 specifically scan for data that triggers take-over events related to a task, item, or request that the agent is configured to converse with the user about. For example, the detection module 202 may look for data indicative of positive sentiment in the input data (e.g., “yes,” “that would be great,” etc.) or other sentiment indicative of positive interest (e.g., “tell me more,” “I like that,” etc.). The detection module 202 may determine that a take-over event is triggered in response to detecting positive sentiment or positive interest in relation to an output from the agent that is related to the take-over event, such as “Do you want to learn more about our warranty” or “Would you like to talk about the return options?”

In some embodiments, the detection module 202 may use several parameters to characterize the stream of input data, and based on these parameters, the detection module 202 may determine whether the stream of input data triggers a take-over event. For example, the detection module 202 may pre-determine a condition and/or a set of parameters. When the stream of input data meets the condition, and/or the parameters associated with the stream of input data meet the pre-determined set of parameters, the detection module 202 may determine that at least of a portion of the stream of input data may be provided to a human agent, e.g., to be treated as a take-over event.

The parameters may include user cue, issue complexity, technical limitation, etc. The parameter of user cue may refer to the user's emotional and/or behavioral signals (e.g., a user repeats a phrase like “this isn't helpful”). The detection module 202 may identify that the user cue parameter is associated with a negative user emotion, e.g., frustration, anger, etc., and determine that input data associated with the negative user emotion is a take-over event to be handled by a human operator. The parameter of issue complexity may describe a level of complexity of an event. An event with high level of issue complexity would demand a significant amount of computing resources if it were handled by the agent of the declarative agent service 130. For example, the detection module 202 may determine the parameter of issue complexity by determining whether there is ambiguity or uncertainty in the stream of input data, whether the stream of input data include a multi-step problem to solve, whether the stream of input data includes a request beyond the agent's knowledge/information, and the like. The parameter of technical limitation describes the technical issues that the agent cannot process. For example, the detection module 202 may identify the stream of input data includes security issues, such as sensitive personal information (e.g., social security number, credit card details, etc.), unsupported requests (e.g., complex refund process, warranty claims, etc.), and the like. In some implementations, the detection module 202 may determine a set of pre-determined thresholds/rules for the take-over event related parameters. When one or more of these parameters meet the pre-determined threshold/rules, the detection module 202 determines at least a portion of the stream of input data triggers a take-over event. For example, the detection module 202 may set a threshold number for failed responses. If the agent cannot resolve an issue after, e.g., three attempts, the detection module 202 may determine the parameter of issue complexity is high and determine the stream of input data includes a take-over event.

In some embodiments, the detection module 202 may use a machine-learning model (e.g., Generative AI 140) to identify one or more take-over events in the stream of input data. For example, the detection module 202 may apply a machine-learning model to the stream of input data and the machine-learning model may output one or more take-over events, and each take-over event may be associated with a confidence score. The confidence score may be used to indicate a likelihood that a human intervention is more efficient, the level of difficulty for an agent to resolve this event, or any other criteria. When one or more of the confidence scores exceed a certain threshold value that is pre-determined by the detection module 202, the detection module 202 may determine the corresponding event is a take-over event and/or should be handled by a human operator.

The detection module 202 may train the machine-learning model to recognize patterns/features/parameters in streams of input data that indicate the need for human intervention. The machine-learning model may be trained to analyze user input, conversation context, and agent performance illustrated in the stream of input data to determine when a take-over event is necessary. The machine-learning model may be a supervised machine-learning model that is trained on a labeled dataset where each input (e.g., stream of user input) is associated with a specific label (e.g., successful agent resolution or take-over event). The machine-learning model may learn from these training examples to generalize and make predictions on new, unseen data.

In some implementations, the detection module 202 may generate a training dataset by gathering streams of user input, historical conversations, user feedback, etc. For example, the detection module 202 may extract queries from historical chat logs where users have previously interacted with either an agent of the declarative agent service 130 or human agents. In some examples, simulated/generated data may be created and used as training examples. In some implementations, each training example may be labeled as either successful agent resolution or take-over event (where human intervention was needed). The detection module 202 may determine features that indicate a take-over event. In some embodiments, the features may be selected based on the take-over parameters, such as user cue, issue complexity, technical limitation, etc. In some embodiments, the features may include, for example, sentiment scores indicating negative emotions, response pattern (e.g., repeated user queries, lack of resolution, etc.), number of misunderstandings or repeated clarification, issue complexity (e.g., multi-step questions, ambiguous requests, etc.), direct request for human intervention, and the like. In some embodiments, the detection module 202 may pre-process the stream of input data. For example, the detection module 202 may perform natural language processing (NLP) to convert audio signals to text. The detection module 202 may tokenize the streams of input data to break down the text into smaller parts, such as words or phrases. In some implementations, the detection module 202 may extract relevant features from the streams of input data to generate training examples and/or input to the machine-learning model.

To train the machine-learning model with the training dataset, the detection module 202 may define an objective function, which guides the machine-learning model in learning to determine a take-over event from a stream of user input. In some implementations, a loss function may be used as the objective function. This loss function measures the difference between the machine-learning model's predicted probabilities and the actual labels, guiding the optimization of the machine-learning model's parameters. During the training process, the machine-learning model may be applied to the training examples, and based on the measured loss, the machine-learning model's weights may be adjusted during training to reduce the loss function and improve the machine-learning model's predictions. The training process involves feeding the training data into the machine-learning model, which iteratively updates its weights based on the feedback from the loss function. For neural networks, this training is often conducted over multiple epochs, with each epoch representing a complete pass through the training dataset. Once the machine-learning model is trained, when receiving a new user input, the detection module 202 may apply the trained machine-learning model to the stream of input data and output one or more take-over events associated with the stream of input data.

In some implementations, feedback on the output from the machine-learning model may be collected to update/retrain the model. For example, after each take-over event, the human operator may provide feedback on whether the transfer was necessary. This data can be used to retrain the machine-learning model and make it more accurate. The detection module 202 may use post-conversation surveys or customer satisfaction scores to evaluate whether take-over events were timely and effective. For example, if users correct the responses or indicate that the agent misunderstood their query, this information may be used as feedback. In some implementations, human operators may review the take-over events to evaluate the machine-learning model's accuracy and identify any recurring issues. In some examples, the detection module 202 may review cases where the machine-learning model either failed to trigger a take-over event when needed or escalated unnecessarily, and fine-tune the machine-learning model accordingly.

Based on the feedback analysis, the detection module 202 may update the training dataset to include new examples, corrections, or additional variations of input data. The detection module 202 may adjust the machine-learning model's architecture, hyperparameters, or training approach based on the feedback. For instance, if the feedback indicates a frequent misunderstanding of certain issues, updating the training dataset to includes these examples and retraining the model with examples of these issues may improve accuracy. In some cases, incremental learning techniques may be applied, allowing the machine-learning model to be updated with new data without requiring a full retrain from scratch.

The event assignment module 204 receives the one or more identified take-over events and requests human operators to handle the identified take-over events. In some implementations, the event assignment module 204 may create a communication channel between the agent and one or more human operators. The event assignment module 204 may upload the take-over events to the communication channel so that the human operators may review and handle the take-over events. In some examples, the event assignment module 204 may assign a ticket with a ticket number to each take-over event. The human operators may pick the take-over events using the ticket number. In some implementations, the event assignment module 204 may rank the take-over events and display the take-over events based on the rank. For example, the event assignment module 204 may rank the take-over events based on the creation time of the event, level of urgency, level of complexity, etc. In some cases, the take-over events may be assigned based on the rank, for instance, a take-over event created earlier in time will be assigned to a human operator to process earlier, or a take-over event having a higher level of urgency will be assigned to a human operator to process earlier, etc. In some cases, the take-over events may be assigned based on the category/type/subject of the take-over events and/or the expertise of the human operators. For example, a take-over event related to refund issues may be assigned to human operators that are specialized for handling refund issues.

In some implementations, the event assignment module 204 may determine a take-over event includes a multi-step problem and split the take-over event to a set of sub-tasks. Each of the set of sub-tasks may be assigned to a human operator so that the set of sub-tasks may be processed simultaneously. In another example, the event assignment module 204 may determine that some of the set of sub-tasks require human intervention while some of the set of sub-tasks may be handled by the agent of the declarative agent service 130. In this case, the event assignment module 204 may upload the sub-tasks that require human intervention to the communication channel and assign them to human operators for process and keep the other sub-tasks for the agent of the declarative agent service 130 to process.

The output module 206 receives a result for each take-over event from the communication channel. The human operators process and generate a result of each of the one or more take-over event uploaded in the communication channel. The output module 206 may dynamically integrate the received results to form an overall response to the stream of input data. In some embodiments, the output module 206 may process and generate results to events other than the take-over events. For example, if the stream of input data includes “How do I reset my password?” the detection module 202 may determine this is not a take-over event and may be handled by the agent of declarative agent service 130. The detection module 202 may transmit this event/request to the output module 206 to generate a result. In this example, the output module 206 may process this request and generate a response, e.g., “I can help with that. Can you let me know your email address that I can send you a link for resetting your password?”

In some embodiments, the output module 206 may receive results from the human operators and process non-take-over events at the same time, e.g., such that human intervention and agent processing are run in parallel. The output module 206 may coordinate the outputs to ensure a seamless user experience. The output module 206 may monitor the completion of processing take-over events and dynamically integrate the results into the ongoing conversation. The output module 206 may dynamically adjust its strategy based on the take-over events and the expected processing time. The output module 206 may form an overall response to the stream of input data and transmit the overall response to the agent of the declarative agent service 130 for responding to the user. In some implementations, the overall response may be in text or voice format. The output module 206 may perform a text to voice conversion to generate an audio signal as a response to the user in a real-time conversation.

In some embodiments, a human operator may take over the conversation temporarily. The human operator may directly communicate with the user for certain take-over events. When the take-over event is completed, the conversation may be switched back to the agent of the declarative agent service 130. In some other cases, a conversation may be entirely taken over by a human operator, and the human operator handles both take-over and non-take-over events.

In some embodiments, the output module 206 may determine that a human operator has not been assigned to one of the take-over events within a threshold amount of time, which may be set by an external operator of the declarative agent service 130. In response to determining that a human operator has not been assigned to one or more of the take-over events within a threshold amount of time, the output module 206 may prompt the agent to continue to facilitate the conversation with the user to keep the user engaged in the conversation while a human operator is determined. The output module 206 may do so by providing additional infromation related to the take-over events, requesting and gathering identification information from the user, or otherwise providing responses that mimic a conversation with a human to keep the user engaged. The output module 206 may continue to do so until an available human operator is identifier for one of the take-over events. In response to receiving an indication that a human operator was selected for a take-over event from the event assignment module 204 or receiving a response from a human operator for the take-over event, the output module 206 may provide the response or create an overall response for presentation in the conversation. The output module 206 may prompt the agent to connect the user to the human operator and “gracefully” (e.g., in a seamless and tactful way) exit the conversation.

The model training module 212 may apply an iterative process to train a machine-learning model whereby the model training module 212 updates parameter values of the machine-learning model based on each of the set of training examples. The training examples may be processed together, individually, or in batches. To train the machine-learning model based on a training example, the model training module 212 applies the machine-learning model to the input data in the training example to generate an output based on a current set of parameter values. The model training module 212 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The model training module 212 updates the set of parameters for the machine-learning model based on the score generated by the loss function. For example, the model training module 212 may apply gradient descent to update the set of parameters.

The data store 214 stores data used by the declarative agent service 130. For example, the data store 214 stores user data, previous conversations, previous take-over events, and the like for use by the declarative agent service 130. The data store 214 also stores machine-learning models trained by the model training module 212. For example, the data store 214 may store the set of parameters for a trained machine-learning model on one or more non-transitory, computer-readable media. The data store 214 uses computer-readable media to store data, and may use databases to organize the stored data.

### Solving Micro-escalation Events

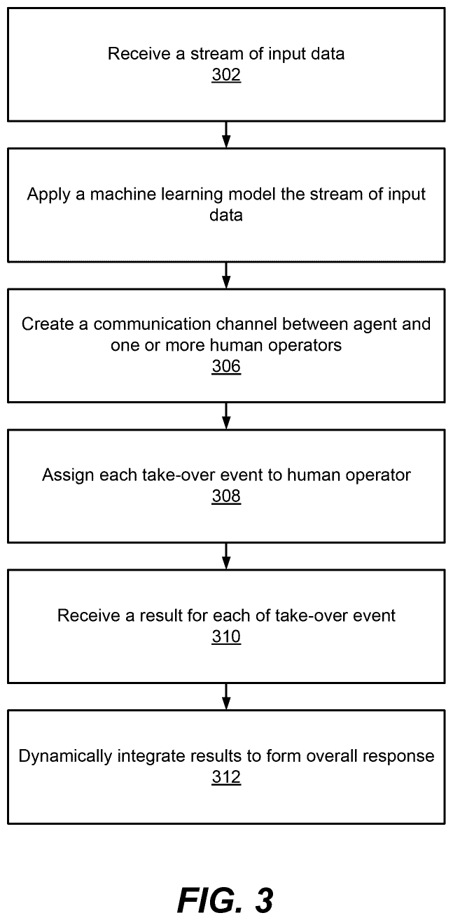

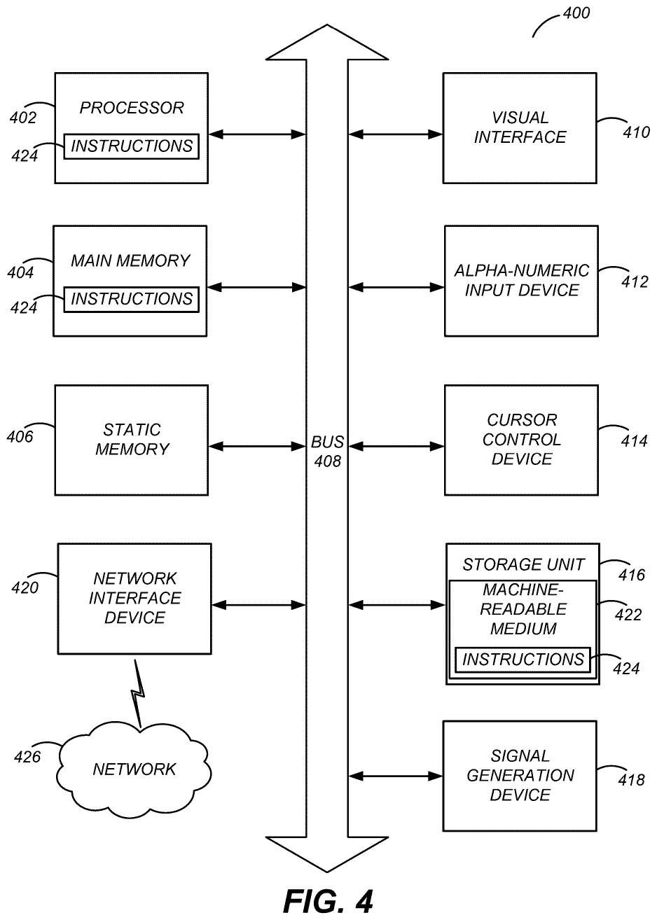

FIG. 3 is a flowchart for a method of solving micro-escalation events using a communication channel, in accordance with one or more embodiments. Alternative embodiments may include more, fewer, or different steps from those illustrated in FIG. 3, and the steps may be performed in a different order from that illustrated in FIG. 3. These steps may be performed by modules of declarative agent service 130, components shown in FIG. 4, or other components external to declarative agent service 130. Additionally, each of these steps may be performed automatically by the declarative agent service 130 without human intervention.

The declarative agent service 130 receives 302, by an agent of the declarative agent service 130, a stream of input data from a user during a real-time conversation between the agent and the user. The agent may be an AI agent powered by a language model. The declarative agent service 130 applies 304 a machine-learning model to the stream of input data to identify one or more take-over events associated with the stream of input data. The declarative agent service 130 creates 306 a communication channel between the agent and one or more human operators. The declarative agent service 130 may provide data indicative of the one or more take-over events to the communication channel, such that human operators with access to the communication channel may view the data (e.g., text describing a take-over event). The declarative agent service 130 assigns 308, using the communication channel, each of the one or more take-over events to one of the one or more human operators. The declarative agent service 130 receive 310, from the communication channel, a result for each of the one or more take-over events that is generated by the respective human operator. The declarative agent service 130 dynamically integrates 312 the received results to form an overall response to the stream of input data during the real-time conversation.

In one example, the declarative agent service 130 may receive a stream of input data from a user, “Hi, I bought a vacuum cleaner from your store, and it stopped working after two months. Can you help me file a warranty claim?” The declarative agent service 130 may apply a machine-learning model to the stream of input data and determine whether the stream of input data includes a take-over event. The machine-learning model may extract certain features from the stream of input data, e.g., user cue (neutral based on the user's tone), task (warranty claim), issue complexity (low, simple request), etc. Using these extracted features, the machine-learning model may determine the stream of input data may include a take-over event of warranty claim with a confidence score of 25%. Assuming the threshold value for a confidence score is 75%, the declarative agent service 130 may determine this stream of input data does not include a take-over event that needs human intervention.

The user may continue to input, e.g., “I don't have the order number right now. The vacuum cleaner was a gift from my friend, but it's under warranty.” In this case the extracted features based on this stream of input data may include: user cue (negative, increased frustration detected based on the user's tone), issue complexity (high, gift-related purchases without order number), etc. The machine learn model may output a take-over event of warrant claim with a confidence score of 85%, which is higher than the threshold. The declarative agent service 130 may then determine that the stream of input data includes a take-over event and transmit the take-over event to the communication channel so that a human operator may handle it.

In some embodiments, the declarative agent service 130 may determine a set of parameters based on the stream of input data. The parameters may be values representing user cues, issue complexities, or technical limitations. In some embodiments, the parameters includes a first level of issue complexity, where the first level of issue complexity is greater than a second level of issue complexity and corresponds to more computing resource usage than the second level of issue complexity. The declarative agent service 130 may compare set of parameters to a pre-defined set of parameters, which may have been set by an external operator of the declarative agent service 130. In response to at least one of the set of parameters matching the pre-defined set of parameters, the declarative agent service 130 may create the communication channel between the agent and the one or more human operators.

In some embodiments, the machine-learning model provides a confidence score for each of the one or more take-over events, where each confidence score indicates a likelihood that human intervention is needed to resolve a task associated with the respective take-over event. In response to a first confidence score exceeding a threshold, the declarative agent service 130 may create the communication channel between the agent and the one or more human operators. The agent service 130 rank the one or more take-over events by confidence score and assign a highest-ranked take-over event to a first human operator based on availability of the human operators. For example, the declarative agent service 130 may access identifiers of human operators who are not handling a take-over event or are otherwise available and select a human operator associated with one or more skills related to the take-over event (e.g., a human operator who specializes in returns, warranties, etc.).

In some embodiments, the declarative agent service 130 receives, for each of the one or more take-over events, feedback from the respective human operator that generated the respective result. The feedback may be indicative of whether or not the respective take-over event was necessary, as indicated by the human operator based on their expertise. The declarative agent service 130 re-trains the machine-learning model on the feedback indicating whether one or more take-over events were necessary. In some embodiments, the declarative agent service 130 determines to split a first take-over event into a set of sub-tasks and simultaneously processes the sub-tasks in the set. For example, the declarative agent service 130 may send each sub-task to its own human operator and generate a response for the first take-over event based on input from each human operator assigned a sub-task.

### Computing Machine Architecture

FIG. 4 is a block diagram illustrating components of an example machine able to read instructions from a machine-readable medium and execute them in a processor (or controller), in accordance with one or more embodiments. Specifically, FIG. 4 shows a diagrammatic representation of a machine in the example form of a computer system 400 within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving, by an agent, a stream of input data from a user during a real-time conversation between the agent and the user;
applying a machine learning model to the stream of input data to identify one or more take-over events associated with the stream of input data;
creating a communication channel between the agent and one or more human operators;
assigning, using the communication channel, each of the one or more take-over events to one of the one or more human operators;
receiving, from the communication channel, a result for each of the one or more take-over events that is generated by the respective human operator; and
dynamically integrating the received results to form an overall response to the stream of input data from the agent into the real-time conversation.

2. The method of claim 1, further comprising:
determining a set of parameters based on the stream of input data, wherein the parameters are values representing user cues, issue complexities, or technical limitations;
comparing the set of parameters to a pre-defined set of parameters; and
in response to at least one of the set of parameters matching the pre-defined set of parameters, creating the communication channel between the agent and the one or more human operators.

3. The method of claim 2, wherein the set of parameters includes a first level of issue complexity, wherein the first level of issue complexity is greater than a second level of issue complexity and corresponds to more computing resource usage than the second level of issue complexity.

4. The method of claim 1, wherein the machine learning model provides a confidence score for each of the one or more take-over events, wherein each confidence score indicates a likelihood that human intervention is needed to resolve a task associated with the respective take-over event, the method further comprising:
in response to a first confidence score exceeding a threshold, creating the communication channel between the agent and the one or more human operators;
ranking the one or more take-over events by confidence score; and
assigning a highest-ranked take-over event to a first human operator based on availability of the human operators.

5. The method of claim 1, further comprising:
receiving, for each of the one or more take-over events, feedback from the respective human operator that generated the respective result, wherein feedback is indicative of whether or not the respective take-over event was necessary;
re-training the machine learning model based at least in part on the feedback indicating whether one or more take-over events were necessary.

6. The method of claim 1, further comprising:
determining to split a first take-over event into a set of sub-tasks; and
simultaneously processing the sub-tasks in the set.

7. The method of claim 1, wherein the agent is an artificial intelligence (AI) agent powered by a language model.

8. A non-transitory computer-readable storage medium storing instructions that, when executed, cause a processor to perform steps comprising:
receiving, by an agent, a stream of input data from a user during a real-time conversation between the agent and the user;
applying a machine learning model to the stream of input data to identify one or more take-over events associated with the stream of input data;
creating a communication channel between the agent and one or more human operators;
assigning, using the communication channel, each of the one or more take-over events to one of the one or more human operators;
receiving, from the communication channel, a result for each of the one or more take-over events that is generated by the respective human operator; and
dynamically integrating the received results to form an overall response to the stream of input data from the agent into the real-time conversation.

9. The non-transitory computer-readable storage medium of claim 8, the steps further comprising:
determining a set of parameters based on the stream of input data, wherein the parameters are values representing user cues, issue complexities, or technical limitations;
comparing the set of parameters to a pre-defined set of parameters; and
in response to at least one of the set of parameters matching the pre-defined set of parameters, creating the communication channel between the agent and the one or more human operators.

10. The non-transitory computer-readable storage medium of claim 9, wherein the set of parameters includes a first level of issue complexity, wherein the first level of issue complexity is greater than a second level of issue complexity and corresponds to more computing resource usage than the second level of issue complexity.

11. The non-transitory computer-readable storage medium of claim 8, wherein the machine learning model provides a confidence score for each of the one or more take-over events, wherein each confidence score indicates a likelihood that human intervention is needed to resolve a task associated with the respective take-over event, the steps further comprising:
in response to a first confidence score exceeding a threshold, creating the communication channel between the agent and the one or more human operators;
ranking the one or more take-over events by confidence score; and
assigning a highest-ranked take-over event to a first human operator based on availability of the human operators.

12. The non-transitory computer-readable storage medium of claim 8, the steps further comprising:
receiving, for each of the one or more take-over events, feedback from the respective human operator that generated the respective result, wherein feedback is indicative of whether or not the respective take-over event was necessary;
re-training the machine learning model based at least in part on the feedback indicating whether one or more take-over events were necessary.

13. The non-transitory computer-readable storage medium of claim 8, the steps further comprising:
determining to split a first take-over event into a set of sub-tasks; and
simultaneously processing the sub-tasks in the set.

14. The non-transitory computer-readable storage medium of claim 8, wherein the agent is an artificial intelligence (AI) agent powered by a language model.

15. A system comprising:
a processor; and
a non-transitory computer-readable storage medium storing instructions that, when executed, cause the processor to perform steps comprising:
receiving, by an agent, a stream of input data from a user during a real-time conversation between the agent and the user;
applying a machine learning model to the stream of input data to identify one or more take-over events associated with the stream of input data;
creating a communication channel between the agent and one or more human operators;
assigning, using the communication channel, each of the one or more take-over events to one of the one or more human operators;
receiving, from the communication channel, a result for each of the one or more take-over events that is generated by the respective human operator; and
dynamically integrating the received results to form an overall response to the stream of input data from the agent into the real-time conversation.

16. The system of claim 15, the steps further comprising:
determining a set of parameters based on the stream of input data, wherein the parameters are values representing user cues, issue complexities, or technical limitations;
comparing the set of parameters to a pre-defined set of parameters; and
in response to at least one of the set of parameters matching the pre-defined set of parameters, creating the communication channel between the agent and the one or more human operators.

17. The system of claim 15, wherein the machine learning model provides a confidence score for each of the one or more take-over events, wherein each confidence score indicates a likelihood that human intervention is needed to resolve a task associated with the respective take-over event, the steps further comprising:
in response to a first confidence score exceeding a threshold, creating the communication channel between the agent and the one or more human operators;
ranking the one or more take-over events by confidence score; and
assigning a highest-ranked take-over event to a first human operator based on availability of the human operators.

18. The system of claim 15, the steps further comprising:
receiving, for each of the one or more take-over events, feedback from the respective human operator that generated the respective result, wherein feedback is indicative of whether or not the respective take-over event was necessary;
re-training the machine learning model based at least in part on the feedback indicating whether one or more take-over events were necessary.

19. The system of claim 15, the steps further comprising:
determining to split a first take-over event into a set of sub-tasks; and
simultaneously processing the sub-tasks in the set.

20. The system of claim 15, wherein the agent is an artificial intelligence (AI) agent powered by a language model.
